(19) United States
(12) Patent Application Publication
(10) Pub. No.: US 2026/0109869 A1
(43) Pub. Date: Apr. 23, 2026

(54) METHODS OF PREPARING FUNCTIONAL SURFACES AND SURFACES PREPARED THEREBY

(71) Applicant: UNIVERSITY OF NORTHUMBRIA AT NEWCASTLE, Newcastle-upon-Tyne (GB)

(72) Inventors: Matthew UNTHANK, Newcastle-upon-Tyne (GB); Frances DAWSON, Newcastle-upon-Tyne (GB); Justin PERRY, Newcastle-upon-Tyne (GB); Darren SMITH, Newcastle-upon-Tyne (GB); Gary WELLS, Newcastle-upon-Tyne (GB); Rodrigo LEDESMA AGUILAR, Newcastle-upon-Tyne (GB)

(21) Appl. No.: 18/870,672

(22) PCT Filed: May 30, 2023
(86) PCT No.: PCT/GB2023/051413

§ 371 Date: Dec. 1, 2024

(30) Foreign Application Priority Data
May 30, 2022 (GB) 2207983.4

(51) Int. Cl. C09D 5/16; C09D 7/40

(52) U.S. Cl. CPC C09D 5/1693; C09D 5/1681; C09D 7/67; C09D 7/68; C09D 7/69; B05D 1/02; B05D 7/52

(57) ABSTRACT

The present invention relates to a method of preparing a hierarchical surface. The method comprises applying a first formulation comprising particles with a median particle diameter, D₅₀, in the range of from 1 nm to 450 nm and a polymeric binder to a substrate, and then applying a second formulation comprising particles with a median particle diameter D₅₀ in the range of from 500 nm to 1000 μm on top of the first formulation. The particles self-assemble to provide a robust hierarchical structured surface. The particles can be functionalised to introduce functionalities, such as anti-viral functionality, which present at the surface. The method can be used to prepare robust, hydrophobic or super-hydrophobic anti-viral surfaces.

The present invention relates to a method of preparing a hierarchical surface. The method comprises applying a first formulation comprising particles with a median particle diameter, D₅₀, in the range of from 1 nm to 450 nm and a polymeric binder to a substrate, and then applying a second formulation comprising particles with a median particle diameter D₅₀ in the range of from 500 nm to 1000 μm on top of the first formulation. The particles self-assemble to provide a robust hierarchical structured surface. The particles can be functionalised to introduce functionalities, such as anti-viral functionality, which present at the surface. The method can be used to prepare robust, hydrophobic or super-hydrophobic anti-viral surfaces.

### BACKGROUND

The advantages of hydrophobic surfaces (i.e. those with a contact angle of 90-150°) and super-hydrophobic coatings (i.e. those with a contact angle≥150°) are evident, particularly in settings such as healthcare. Structured hierarchical surfaces can achieve super-hydrophobic properties, such as those exhibited in nature by the lotus leaf. Super-hydrophobic surfaces repel liquids such as water. The low surface energy of the surface combined with the hierarchical structure causes liquid drops to roll off the surface, leading to a “self-cleaning” phenomenon. However, while such biomimetic structured surfaces have been explored in the scientific literature, practical efforts to exploit these properties in commercial coatings have largely failed. Synthetic approaches to complex biomimetic structured surfaces typically suffer from lack of robustness, with the structures being removed on contact or light abrasion. Whilst routes to more robust surfaces have been investigated, such methods are typically labour intensive and generally not suitable for larger scale application, whilst the ability to exploit the functionality of the upper molecular surface is often lacking. Mechanically robust surfaces that deliver both long-term functional properties, such as anti-viral or anti-microbial properties, alongside self-cleaning properties, are highly desirable.

An example of a commercially available hydrophobic coating based on a structured surface is Glaco™ mirror coat, a glass care coating which is comprised of a suspension of hydrophobic nano-silica in solvent. However, hydrophobic structured surfaces such as these suffer from the aforementioned lack of robustness, and are typically not resilient to wiping, abrasion or skin contact, thereby limiting their use in many applications where a more robust surface is desirable.

More hydrophilic metal oxide coatings are known for providing functional surfaces; however, these metal oxide coatings tend to make less effective self-cleaning surfaces due to their hydrophilic nature which attracts rather than repels water droplets, and often require controlled depletion or polishing in order to keep the surface free from fouling.

The use of tethered functionality, such as tethered anti-viral functionality, is important for the provision of low maintenance, long-lasting functional surfaces. In addition, the tethering of the functionality is of significant environmental benefit, as it avoids leaching of active particles into the environment, which is a known disadvantage of existing coating technologies. However, bringing together a hydrophobic or super-hydrophobic surface designed to repel attachment and provide self-cleaning properties, while also delivering surface functionality, is a difficult balancing act to reconcile.

In summary, whilst mechanically robust surfaces that deliver both long-term functional properties (such as anti-viral, anti-microbial etc) alongside self-cleaning properties are highly desirable, the preparation of such systems is fraught with technical challenges. Known methodologies suffer from issues such as complex processing, the requirement for specialised equipment and/or techniques, high cost, lack of scalability and/or lack of robustness of the surface.

It would be advantageous to provide a versatile method of preparing hierarchical structured surfaces which obviates or mitigates one or more of these disadvantages.

### SUMMARY OF THE INVENTION

According to a first aspect of the present invention there is provided a method of preparing a hierarchical structured surface, the method comprising:
applying a first formulation, the first formulation comprising particles with a median particle diameter, D₅₀, in the range of from 500 nm to 1,000 μm, and a polymeric binder; and subsequently applying a second formulation comprising particles with a median particle diameter, D₅₀, in the range of from 1 nm to 450 nm on top of the first formulation;
to prepare a hierarchical structure.

A “hierarchical structure” is a multi-tiered structure. The formation of a hierarchical structure can be confirmed by appropriate imaging, such as AFM. In the present application, the formation of a hierarchical structure has been demonstrated by topographic images acquired using AFM, with height-mapping showing the height of the features on the surface. These demonstrate that application of the first formulation, containing both a polymer binder and particles, delivers a coating that is structured with particles protruding from the polymeric binder surface. Applying a second formulation comprising particles then coats the surface of structured surface to deliver a hierarchical structured surface. The structural features of the first structured surface, and the resulting hierarchical structured surface after the second formulation has been applied, can be clearly seen with AFM imaging.

The particles may be silica particles. Alternatively, the particles may be, for example, noble metals, metal oxides, metal nitrides, metal chalcogenides or allotropes of carbon, including silica coated derivatives of all of the above. Such particles are commercially available, such as those available from Evonik™ Industries. The particle diameter, D₅₀, of the particles, can be measured using laser diffraction following ISO 13320.

The polymeric binder is not particularly limited once it can be used to form a layer on the substrate and can bind or adhere particles to the substrate surface. Suitable polymeric binders include, but are not limited to, polydimethylsiloxane (PDMS), polyurethanes, polysilicones, polysiloxanes, polyacrylates, polyolefins, polyesters, polycarbonates, polyamides, polyamines, epoxies, epoxy-amines, epoxy-phenols, epoxy-polyesters, melamines, melamine formaldehydes, and alkyds. Such materials are known to those skilled in the art.

Preferred polymeric binders may be chosen based on the intended use of the surface—for instance for some applications, optically transparent and/or colourless polymeric binders may be preferred. Ideally, the polymeric binder can be used to form a thin, continuous layer on the substrate. In an embodiment, the polymeric binder is PDMS. The binder may be a two-component adhesive made from a polymer and an appropriate curing agent, known to those skilled in the art. An example of this is polyurethanes, polysilicones, polysiloxanes, polyacrylates, polyolefins, polyesters, polycarbonates, polyamides, polyamines, epoxies, epoxy-amines, epoxy-phenols, epoxy-polyesters, melamines, melamine formaldehydes, and alkyds when formulated with an appropriate curing agent.

In an embodiment, the polymeric binder may be diluted in a solvent. This may be done, for instance, when the formulation is to be applied by spraying, as would be understood by one skilled in the art. As would be understood, when the polymeric binder is diluted, a cure accelerator may be added to the first formulation if needed for the polymer to harden. The need for a cure accelerator to be added, and the relative amount thereof, could be determined by a skilled person based on the specific polymer used, without inventive skill or undue burden.

In an embodiment, the first formulation comprises a cure accelerator.

In an embodiment, the second formulation comprises a cure accelerator.

In this context, the term “cure accelerator” explicitly includes both cure catalysts (i.e. which remain unchanged by the reaction) and cure accelerators (which are changed or subsumed by the reaction).

In an embodiment, the second formulation comprises a cure accelerator for the polymeric binder of the first formulation. The selection of an appropriate polymeric binder and cure accelerator combination would be within the remit of a skilled person. For instance, when the polymeric binder is PDMS, a homogeneous platinum-based catalyst (platinum-divinyltetramethyldisiloxane complex, commonly known as Karstedt catalyst), which is known for use with addition cure thermoset PDMS binders, can be used. Alternatively other transition metal catalysts can be used for addition cure PDMS including (but not exclusively) Speier's catalyst (H₂PtCl₆), ruthenium and rhodium catalysts. The polymeric binder may also be used with a cure accelerator in the first formulation, e.g., where it is a two-component binder/adhesive formulation. In this case, the same cure accelerator which is used in the second formulation may also be used in the first formulation. Alternatively, a different cure accelerator could be used in the second formulation.

When the cure accelerator is included in the second formulation, the application of the second formulation on top of the first formulation causes the surface of the first formulation to cure, leaving the bulk curing rate substantially unchanged. As demonstrated by the inventors, this successfully expands the application window, i.e., the time period in which the second formulation can be applied over the first formulation, while achieving the robust hierarchical structured surface according to the invention. In addition, the resultant hierarchical structures are shown to exhibit improved resistance to mechanical damage when the cure accelerator is used in the second formulation.

In an embodiment, the application window can range from 20 minutes to 1 hour, from 25 minutes to 50 minutes. As would be appreciated by one skilled in the art, the application window can be optimised depending on the materials used. In one embodiment, a successful application window is one which results in a hierarchical structured surface exhibiting a stable static water contact angle of 140°.

In an embodiment, the particles of the first formulation have a median particle diameter, D₅₀, in the range of from 1 μm to 100 μm. In an embodiment, the particles of the second formulation have a median particle diameter, D₅₀, in the range of from 1 nm to 100 nm.

In an embodiment, the particles of the first formulation have a median particle diameter, D₅₀, in the range of from 1 μm to 20 μm, or from 1 μm to 10 μm. In an embodiment, the particles of the second formulation have a median particle diameter, D₅₀, in the range of from 1 nm to 50 nm.

As a skilled person would appreciate, the particles of the first and second formulations should be sufficiently distinguished in size such that their complementary properties can be exploited to create the hierarchical structure. For instance, the particles of the second formulation should have a median particle diameter D₅₀, which is 50% or less than that of the particles of the first formulation, or which is 75% or less, 90% or less, or 95% less of that of the particles of the first formulation.

In an embodiment, the particles of the second formulation are hydrophobic. In this context, “hydrophobic” means that the particles of the second formulation have a static water contact angle of 90°, when spray applied directly to a glass substrate. This can be measured by droplet shape analysis.

In an embodiment, the particles of the second formulation are functionalised.

In some embodiments, the hydrophobicity of the particles of the second formulation can be achieved functionalising the particles. For instance, the particles of the second formulation can be functionalised with a functional group comprising a C1-C25 alkyl group.

In some embodiments, the particles of the second formulation can be functionalised to impart desired properties to the surface. Due to the hierarchical nature of the resultant structure, functionalisation of the particles of the second formulation allows the functional properties to be exploited at the surface. This means that properties such as anti-viral, anti-bacterial or anti-microbial properties, can be incorporated into the hierarchical structure and presented at the surface.

In an embodiment, the particles of the second formulation are anti-viral. Anti-viral or virucidal properties can be imparted by incorporating appropriate anti-viral functionality onto the particles of the second formulation. For instance, in an embodiment the particles of the second formulation can be functionalised with a quaternary ammonium group, an amino group or a phosphonium group.

In an embodiment, the particles of the second formulation can be functionalised with a C1-C25 alkyl functional group containing a quaternary ammonium group. This imparts both hydrophobicity due to the presence of the alkyl chain, and anti-viral properties due to the presence of the cationic quaternary ammonium group, onto the particles of the second formulation. In addition, quaternary ammonium groups are known to exhibit anti-bacterial, anti-fungal and anti-microbial properties, and the incorporation of cationic quaternary ammonium groups can therefore impart these functionalities to the structured surface.

When the particles of the second formulation are functionalised with a C1-C25 alkyl functional group containing a quaternary ammonium group, then the C1-C25 alkyl functional group is preferably a C6-C25 alkyl chain.

In an embodiment, the first formulation and/or the second formulation comprises a solvent. As would be readily appreciated by one skilled in the art, the purpose of the solvent is to act as a vehicle to allow the formulation to be applied effectively, for instance by spraying, and the solvent is not particularly limited once this can be achieved. Any suitable solvent can therefore be used, but for exemplary purposes only, suitable solvents include water, methanol, ethanol, iso-propanol, butanol, hexanol, ethyl acetate, isopropyl acetate, n-propyl acetate, butyl acetate, diethylether, diisopropylether, tert-butylmethylether, tetrahydrofuran, toluene, xylene, petroleum ether, hexane and heptane.

In the method of the invention, the second formulation is applied over the first formulation. The first formulation is applied to an appropriate surface, and subsequently the second formulation is applied. The method comprises applying a first formulation, the first formulation comprising particles with a median particle diameter, D₅₀, in the range of from 500 nm to 1,000 μm, and a polymeric binder, so that the particles protrude from the binder; and subsequently applying a second formulation comprising particles with a median particle diameter, D₅₀, in the range of from 1 nm to 450 nm; to prepare a hierarchical structure. Protrusion of the particles from the binder can be verified by known techniques, such as, for instance, AFM.

The first formulation can be applied by spray coating, although a skilled person would readily understand that the invention is not limited thereto.

Suitable spray coating can be performed, for example, with a spray gun, such as a Sparmax spray gun (GP-35) fitted with a hopper and air compressor (Fengda FD-196 Piston Type 186W), The first formulation can be applied in a single coat, or in a number of coats. For example, the first formulation may be applied using from 1 to 10 or from 1-5 coats. Advantageously, the application of the first formulation can be carried out using a simple spray gun, avoiding the need for specialist equipment.

The second formulation is applied on top of the first formulation. Again, the second formulation can be applied by spray coating, in the same manner as for the first formulation. Again, the formulation may be applied using from 1 to 10 or from 1 to 5 coats. Applying multiple coats allows good coverage to be achieved, and this can be optimised by a skilled person without the exercise of inventive skill.

Alternatively, other methods could be used to apply one or both formulations—for instance, dip coating, brush coating or roller coating could be used. However, spray coating is highly advantageous as it avoids the need for specialist equipment and allows the methodology to be easily scaled-up, as would all be appreciated by a person skilled in the art.

The invention will now be described by reference to the Figures, in which:

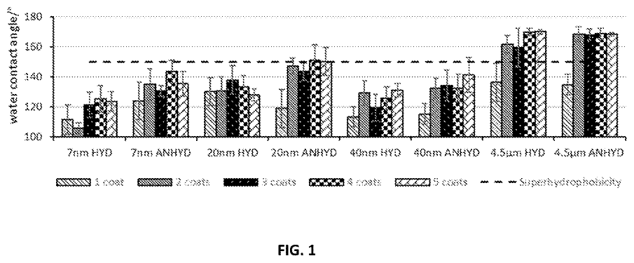

FIG. 1 shows the effect of the number of coats and functionalization method on the average water contact angle of spray coated slides across a range of different particle sized silicas, functionalized with the hydrophobic C18Si agent;

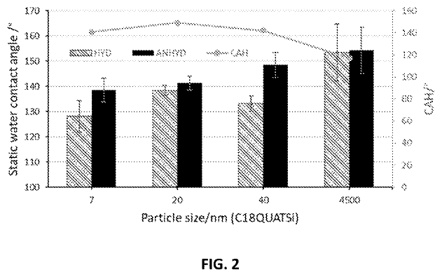

FIG. 2 shows the effect of particle size on static water contact angle and CAH functionalized with C18QUATSi under hydrous and anhydrous conditions (5 coats). CAH shown for anhydrous series;

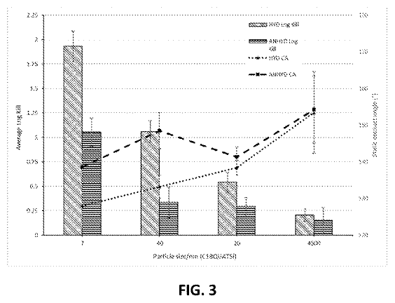

FIG. 3 shows the relationship between antiviral efficacy and static contact angle in C18QUATSi functional coatings, across a range of particle sizes;

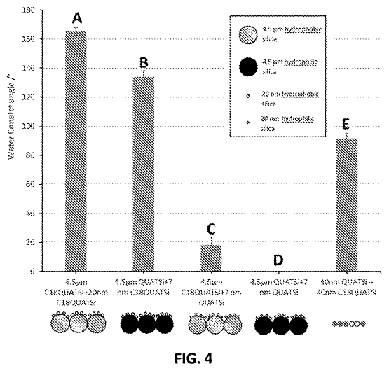

FIG. 4 shows static water contact angle of hierarchical structured surfaces based on 4.5 μm and 7 nm functionalized (C18QUATSi and C18Si) silica particles, prepared by single spray application;

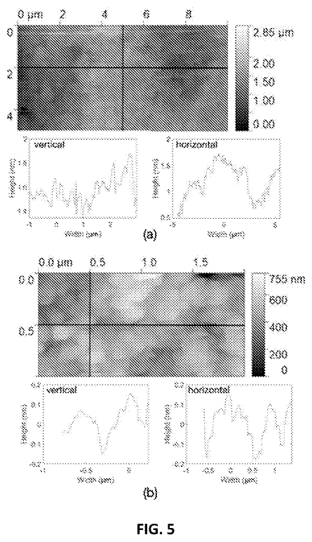

FIG. 5 shows topographic images acquired using AFM over an area of (a) 10×5 μm and (b) 2×1 μm, showing the presence of a hierarchical nano-on micro-surface structure. Horizontal and vertical line scans are obtained over lines shown in the topographic images;

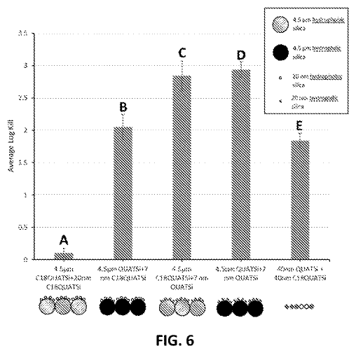

FIG. 6 shows antiviral efficacy evaluation of self-assembled hierarchical structured surfaces from 4.5 μm and 7 nm functionalized (C18QUATSi and C18Si) particles, prepared by single spray application;

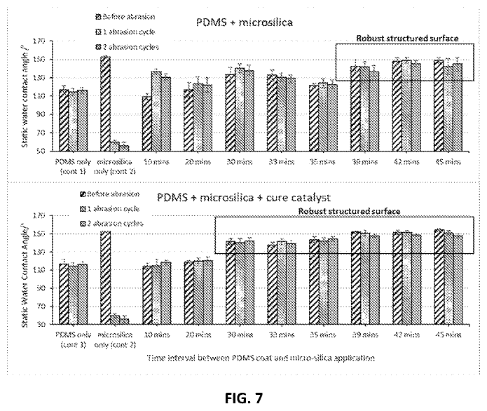

FIG. 7 shows an application window study of particle adhesion to identify the optimal conditions for adhesion of micro-silica to a partially cured PDMS adhesive under ‘normal’ (top) and ‘cure catalyst’ accelerated (bottom) conditions;

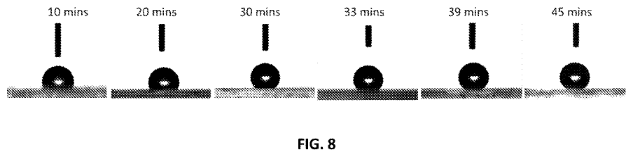

FIG. 8 shows droplet images after spraying micro-silica (4.5 μm, C18Si) onto PDMS binder after different time intervals;

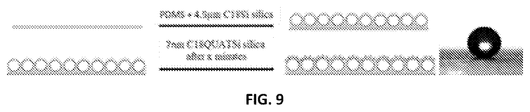

FIG. 9 is a schematic showing the application process for the creation of robust, nano-on micro-hierarchical structured coatings according to the invention;

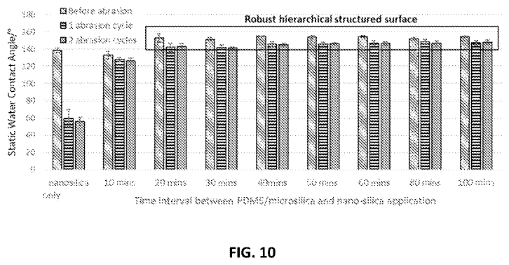

FIG. 10 shows an application window study for the cure catalyst accelerated preparation of robust, nano-on micro-hierarchical structured coatings;

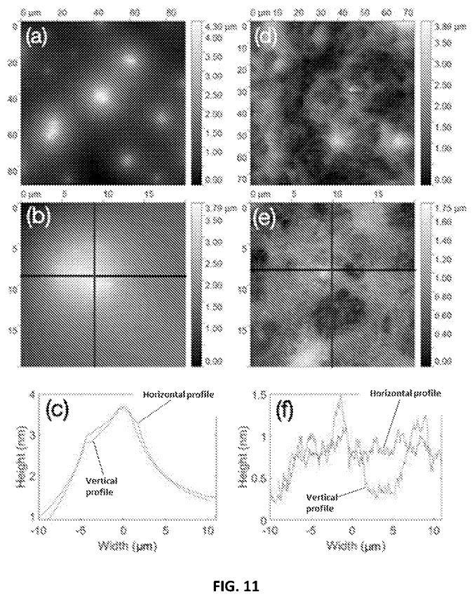

FIG. 11 shows topographic images acquired using AFM showing the distribution of micro-particles, over an area of (a) 90×90 μm and (b) 20×20 μm on micro-structured (PDMS, 4.5 μm, C18Si) base layer. The line scans (c) show the height of the features on the micro-structured base layer. The ‘nano-on micro-structured surfaces’ are visible when the hierarchical structured surfaces are scanned over an area of (d) 75×75 μm and (e) 20×20 μm. The line scan (f) shows resolution of both the micro- and nano-surface features.

### MATERIALS AND METHODS

### Materials

Commercially available silica particles, of known D₅₀, were used in the preparation of the structured surface. OH-functional (hydroxyl-functionalised) silica particles used were AEROSIL300™ (7 nm diameter), AEROSIL90™ (20 nm diameter), AEROSILOX50™ (40 nm diameter) and SIPERNAT™ 350 (4500 nm/4.5 μm diameter) supplied by Evonik™ Industries. Silane functionalisation agents n-tetradecyldimethyl(3-trimethoxysilylpropyl)-ammonium chloride (C14QUATSi, 50% in methanol), dimethyloctadecyl[3-(trimethoxysilyl)propyl]ammonium chloride (C18QUATSi, 60% in methanol), trimethoxy(octadecyl)silane (C18Si) and N-trimethoxysilylpropyl-N,N,N-trimethylammonium chloride (QUATSi, 50% in methanol) were supplied by FluoroChem or Fisher Scientific™ and used as received. All solvents used were standard laboratory grade supplied by Fisher Scientific™. Infrared analysis was carried out using a Brucker Platinum-ATR and OPUS 7.0 software.

### Standard Procedures

### 1.1 Static and Dynamic Contact Angles

Static contact angles were all measured using a Kruss drop shape analyser (DSA30). For each sample, 4×2 μl droplets were measured and an average contact angle with standard deviation was recorded using the in-build angle tool on the DSA. To measure the contact angle hysteresis (CAH) samples were placed onto an Aerotech 2 axis tilting stage mounted on Thorlabs™ XYZ translational stages and levelled with a Level Developments Engineering level accurate to 50 μm in the metre. Droplets were generated using an Exigo™ microfluidic syringe pump, held above the surface using a Thorlabs™ translational stage. The initial DI water droplet volume was 2 μl, generated at 0.5 μl/s, through a 0.7 mm outer diameter flat tipped needle before being placed onto the surface. To identify the surfaces advancing angle, the original 2 μl droplet was inflated by 4 μl at a flow rate of 0.1 μl/s. The flow was then reversed (−0.1 μl/s) to deflate the droplet and obtain the receding angle. In some cases, the removal of 4 μl of DI water in the deflation step did not result in motion of the pinned contact line, therefore the initial 2 μl of liquid was removed as well. The inflation and deflation procedures were recorded with a Navitar™ 4.0× zoom lens and 0.5× objective attached to an IDS USB camera. The subsequent advancing and receding angles were extracted from the corresponding frames of the video using the angle tool in ImageJ. 5 droplets per sample type were measured to get average receding/advancing angles.

### 1.2 Atomic Force Microscopy

The topographic images of the coating surface were acquired using a commercial AFM system (Veeco DI3100, Bruker™ Corporation). Tapping mode imaging techniques were applied using a cantilever with a stiffness of 26 N/m and tip radius of 7 nm (OTESPA, Bruker™). The samples were imaged with different scan sizes to investigate the hierarchical structures.

### 1.3 Particle Functionalisation and Formulation

OH-functional silica particles (0.75 g) were suspended in either toluene (75 mL, ANHYD) or ethanol:water (100 mL, HYD) respectively. Each suspension was treated with silane functionalisation agent (0.75 mmol) selected from n-tetradecyldimethyl(3-trimethoxysilylpropyl)-ammonium chloride, 50% in methanol [C14QUATSi], dimethyloctadecyl[3-(trimethoxysilyl)propyl]ammonium chloride, 60% in methanol [C18QUATSi], trimethoxy(octadecyl)silane [C18Si, control] and N-trimethoxysilylpropyl-N,N,N-trimethylammonium chloride, 50% in methanol [QUATSi, control]. Two methodologies were investigated, as detailed below.

### 1.3.1 Anhydrous Functionalisation Method (ANHYD)

OH-functional silica particles (0.75 g) were suspended in toluene (75 mL, ANHYD) and heated for 4 hours at reflux, under nitrogen with stirring. The suspension was allowed to cool before centrifuge sedimentation (3000 rpm, 10 mins), decanting the solvent from the particles and washing three times with ethanol and once with propan-2-ol (centrifuging and decanting in-between each washing cycle). The silicas (0.75 g) were then suspended in propan-2-ol (75 ml), sonicating with a MSE Soniprep™ 150 Plus tip sonicator (15 mins, 14 micron amplitude, over ice) to produce a silica suspension for spraying.

### 1.3.2 Hydrous Functionalisation Method (HYD)

OH-functional silica particles (0.75 g) were suspended in ethanol:water (50:50, 75 mL, HYD) and heated for 4 hours at reflux, under nitrogen with stirring. The suspension was allowed to cool before centrifuge sedimentation (3000 rpm, 10 mins), decanting the solvent from the particles and washing three times with ethanol and once with propan-2-ol (centrifuging and decanting in-between each washing cycle). The silicas (0.75 g) were then suspended in propan-2-ol (75 ml), sonicating with a MSE Soniprep™ 150 Plus tip sonicator (15 mins, 14 micron amplitude, over ice) to produce a silica suspension for spraying.

### 1.4 Antiviral Testing

Using a modified method derived from Haldar et al, to allow semi-high throughput testing, a high titre stock of bacteriophage Phi6 (DSM 21518), was raised against bacteria Pseudomonas syringae (DSMZ 21482), [kindly deposited to DSMZ by Sylvain Moineau, University of Laval, Quebec, Canada]. Bacteriophage titres of >1×10\hat{ }8 pfu·ml were used as part of the surface tests. Each cover slip (test surface or glass control) were placed into individual wells on a 6 well plate. To each test surface 10 μl of bacteriophage stock in Lysogeny broth (LB media+0.01M CaCl₂) was added to the surface and immobilised across the slide by addition of a cover slip. This was then incubated for 1 h at room temperature ^{˜}18-20° C. The samples were submerged in 1 ml of LB buffer and coverslip removed, and surfaces washed with gentle pipetting. The test LB containing remnant bacteriophages were subject to 10-fold serial dilution. A phage overlay plate was created the lower layer LB buffer with 1.2% w/v Difco Bacterial Agar, overlaid with LB with 0.4% w/v Difco agar, containing 100 μl of Pseudomonas syringae with culture optical density of 0.5-0.7 OD600. To the bacterial overlay 10 μl of each dilution was added, allowed to dry and incubated ^{˜}18 h, at 25° C. Individual plaques were counted, to offer the remaining viable bacteriophages after test.

### EXAMPLES

### 2.1 Preparation of Functionalised Particles

A range of particles (7, 20, 40 and 4,500 nm diameter), were surface functionalised using each of the two methods described in Standard Procedures Section 1.3, i.e., 1.3.1 (ANHYD) and 1.3.2 (HYD). For each method, the particles were functionalised with a range of alkoxysilanes containing i) cationic C14/C18 alkyl quaternary ammonium groups (C14QUATSi and C18QUATSi), ii) neutral C18 alkyl groups (C18Si, control) and iii) cationic trimethyl quaternary ammonium group (QUATSi, control). The C18Si and QUATSi agents were included in the study as controls, which lacked either i) the cationic functionality (C18Si), or ii) the hydrophobic alkyl chain (QUATSi). Successful functionalization of the silica particles was confirmed by infra-red spectroscopy which clearly showed C—H stretching (3000-2840 cm-1) and C—H bending (1465 cm-1).

### 2.2 Coating of Functionalised Particles

Glass microscope coverslips were adhered to microscope slides (3 per slide) with pressure adhesive putty.

Functionalised silica particles were dispersed in propan-2-ol (1 wt %). The glass slides were then spray coated with the silica suspensions using a Sparmax™ spray gun (GP-35) fitted with a hopper and air compressor (Fengda FD-196 Piston Type 186W) allowing 20-30 seconds for the substrates to dry between coats. The coverslips (still attached to the glass microscope slides) were then immersed in distilled water for 5 minutes, removed and rinsed with 50 ml distilled water from a measuring cylinder. Excess water was shaken off and the samples were allowed to dry at room temperature overnight.

### 2.2.1 Effect of Particle Size on Contact Angle

### 2.2.1.1: C18Si-Functionalised Particles

To investigate the effect of particle size on hydrophobicity, the C18Si-functionalised silica suspensions covering the 7, 20, 40 and 4500 nm diameter range, were applied with increasing numbers of coats (from 1-5 coats) and the results are shown in FIG. 1. Across all particle sizes, an increase in static contact angle on application of additional coats (2 to 5 coats) was observed. Differences in static contact angle could also be observed when comparing the surface functionalization methods, particularly across the lower particle size silicas. Within the 7 and 20 nm series for example, the ‘anhydrous method’ (ANHYD) delivered more hydrophobic surface properties as characterised by higher static contact angles (see FIG. 1).

The results indicate that superhydrophobicity (static contact angle>150°) is achievable through control of particle size, with the larger 4.5 μm particle treated with hydrophobic C18Si consistently delivering contact angles above 150°, irrespective of the mode of C18Si functionalisation, whilst the nano-structured surfaces were generally <150° and therefore not indicative of a super-hydrophobic surface. These suggest that larger particles are significant for achieving a super-hydrophobic surface.

### 2.2.1.2: C18QUATSi-Functionalised Particles

The results for the particles functionalised with the hydrophobic quaternary ammonium (antiviral) functionalization agent C18QUATSi are shown in FIG. 2. The structured surfaces showed a gradual increase in static water contact angle with particle diameter irrespective of the mode of functionalisation used, similar to that observed with the C18Si series shown in FIG. 1. Under both hydrous and anhydrous methods, the contact angles increased to ^{˜}154° for 4.5 μm from ^{˜}128°/138 (HYD/ANHYD) for 7 nm particles. These data are in general lower than the equivalent surfaces functionalized with the C18Si functionalization agent, which can achieve a static contact angle of >160°.

A superhydrophobic surface can be characterised as having both a high static contact angle and a low contact angle hysteresis (CAH), (e.g., a high receding angle). The advancing and receding angles for all structured surfaces were measured, giving a measurement of CAH. FIG. 2 (right y-axis) shows CAH for C18QUATSi structured surfaces across a range of different particle sizes. All entries show very high CAH (117-149°) regardless of particle size across the C18QUATSi series. The high degrees of CAH are linked to the presence of the polar quaternary ammonium group embedded within the non-polar alkyl chain surface functionality which results in the amphiphilic surface characteristics of high static contact angle, while still exhibiting high CAH (due to water droplet pinning). This is supported by a much lower CAH (measured at 28°) for an equivalent (40 nm diameter) structured surface functionalized with the C18Si functionality (i.e. lacking the amphiphilic character of C18QUATSi). These results suggest that the presence of the C18QUATSi is detrimental to the hydrophobicity characteristics of the particles.

### 2.2.2 Effect of Particle Size on Anti-Viral Activity

Antiviral testing of the full range of surfaces was conducted to understand the relationship between antiviral efficacy and hydrophobicity. This was performed using the bacteriophage Phi6, an enveloped surrogate model for the SARS-CoV-2 virus (Poranen, M. M. et al ICTV Virus Taxonomy Profile: Cystoviridae. J. Gen. Virol. 2017, 98 (10), 2423-2424. https://doi.org/10.1099/jgv.0.000928; Adcock, N. J. et al., The Use of Bacteriophages of the Family Cystoviridae as Surrogates for H5N1 Highly Pathogenic Avian Influenza Viruses in Persistence and Inactivation Studies. J. Environ. Sci. Heal.—Part A Toxic/Hazardous Subst. Environ. Eng. 2009, 44 (13), 1362-1366. https://doi.org/10.1080/10934520903217054; Casanova, L. M.; et al. Evaluation of Eluents for the Recovery of an Enveloped Virus from Hands by Whole-Hand Sampling. J. Appl. Microbiol. 2015, 118 (5), 1210-1216. https://doi.org/10.1111/jam.12777) in a semi high through-put method developed for testing spray coatings for antiviral surface activity (see Standard Procedures Section 1.4).

20 mm×20 mm glass slide covers were coated (in triplicate) and immersed in 6-well plates. Bacteriophage-containing droplets were incubated for 1 hour on these coated surfaces and the reduction in viral titre measured using established methodologies (Haldar, J. et al., Preparation, Application and Testing of Permanent Antibacterial and Antiviral Coatings. Nat. Protoc. 2007, 2 (10), 2412-2417. https://doi.org/10.1038/nprot.2007.353.). Across the full range of coatings, an inverse correlation was generally identified between antiviral efficacy (measured by log kill) and hydrophobicity, i.e. as the static water contact angle increased, reflecting greater hydrophobicity, the anti-viral activity reduced. FIG. 3 shows a representative subset of the data to illustrate this trend with C18QUATSi functional particles.

In the most efficacious example (C18QUATSi, HYD, 7 nm) the particle achieved a log kill of 1.93 with a corresponding static contact angle of 128°. Across the 7-40 nm particle sizes, the hydrous functionalisation method (‘HYD’, FIG. 3) shows both higher log kill and corresponding lower static contact angles, than the ‘anhydrous’ functionalisation method (‘ANHYD’, FIG. 3), although both performed to an acceptable level. The C18Si functional coating (i.e. with no quaternary ammonium functional group) delivered very high static contact angle (^{˜}160°) but no detectable anti-viral efficacy (i.e. zero log kill). In contrast, the QUATSi (no hydrophobic alkyl chain) delivered the highest log kill values of 2.5-3.0, with complete surface wetting (i.e. no measurable static contact angle). These results demonstrate the tension between the hydrophobic and anti-viral properties sought.

### 2.3 Preparation of Self-Assembled Hierarchical Structured Surfaces

A single formulation comprising both the hydrophobic (C18QUATSi) and hydrophilic (QUATSi) functionalised antiviral particles was prepared, and spray applied to glass substrates by spray application to prepare a range of coatings.

To prepare the mixed particle size suspensions dispersions, silica solutions of different particle sizes and surface functionalities (1 wt % in propan-2-ol) were combined in a 50:50 volume ratio according to Table 1, and were sonicated for 10 minutes to give particle suspension of bimodal particle size distribution. The resulting suspensions were then applied to vertically arranged glass substrates by spray application using a Sparmax spray gun (GP-35) fitted with a hopper and air compressor (Fengda FD-196 Piston Type 186W, 1-2 bar). Initially, 5 mL of propan-2-ol was placed into the spray gun and sprayed onto the glass substrates at a distance of 15 cm to clean the glass substrate. The silica suspensions were sonicated immediately prior to application using a 60 W ultrasonic bath (VGT-1620QTD) for 10 minutes. The silica suspensions (1 wt % in propan-2-ol) were then charged to the spray gun allowing a volume of 0.5 mL per slide, per coat. The suspensions were sprayed, allowing 20-30 seconds for the substrates to dry between coats (after which time the coated substrates were visually dry). The coating process was repeated until the desired number of coats was obtained. Once the spray application was complete, the spray gun emptied and cleaned with 5 mL of toluene, spraying into tissue paper.

The structure of the surfaces was studied by AFM, which confirmed that the bimodal suspensions based on A to D has self-assembled to form hierarchical structured surfaces. For control mixture E [40 nm silica with C18QUATSi; 40 nm silica with QUATSi], no hierarchical structure was formed, as mixture E contained particles of only 40 nm in diameter.

In total 4 combinations of hydrophobic/hydrophilic micro and nano silica were tested (Mixtures A-D). All silica used were functionalized using the ANHYD functionalisation conditions. The wetting behaviour, antiviral efficacy and surface structure of the functionalised surfaces were then studied.

TABLE 1
Bimodal silica suspensions.

| Mixture | 4.5 μm silica | 20 nm silica |
|---|---|---|
| A | C18QUATSi | C18QUATSi |
| B | QUATSi | C18QUATSi |
| C | C18QUATSi | QUATSi |
| D | QUATSi | QUATSi |
| Mixture | 40 nm silica | 40 nm silica |
| E | C18QUATSi | QUATSi |

### 2.3.1 Static Water Contact Angle

Structured coating system A (20 nm and 4.5 μm particles each functionalised with C18QUATSi) showed the highest static contact angle seen thus far from amphiphilic C18QUATSi functional particles (>165°, FIG. 4). This is significantly beyond that possible from single-tiered particle surfaces (i.e. 7 nm particles gave a contact angle of only 139° and 4.5 um particles gave a contact angle of 154°), showing the benefit of a hierarchical structure in delivering superhydrophobicity. Most importantly, coating system A demonstrated a step-change in CAH, measuring only 7° (in comparison to 140-142° for the individual particle structured surfaces) effectively eliminating the water drop pinning behaviour previously seen. Using this approach to control contact angle behaviour, the nature of surface chemical functionality has been decoupled from the wetting behaviour. Specifically, the hierarchical structured surface overrides the amphiphilic ‘droplet pinning’ nature of C18QUATSi based coatings (at both the nano- and micro-particle size) delivering both high static contact angles with low CAH. With this chemical treatment, water droplets could be observed rolling across a surface to deliver easy-clean or even self-cleaning performance characteristics from a superhydrophobic surface.

To demonstrate this technique's ability to control surface and wetting behaviour, the properties of coating systems B-E were investigated (FIG. 4). Structured coating B was created with 50 wt. % 4.5 μm QUATSi particles and 50 wt % 20 nm C18QUATSi particles. These particles self-assembled into a structured surface with the C18QUATSi antiviral hydrophobic nanoparticles layer over a larger dimension QUATSi micro-particle base layer. Experimentation showed that the surface properties of this coating are dominated by the hydrophobic nature of the nano-structured upper tier, delivering a high static contact angle of 134°. The exposed surface of the coating is therefore composed of hydrophobic (C18QUATSi) nanoparticles, rather than hydrophilic (QUATSi) microparticles. This indicates that the bimodal suspension of particles self-assemble on application to deliver a hierarchical structured surface.

By contrast, the relative hydrophobicity of a non-hierarchical structured surface based on the same wt. % composition of hydrophilic:hydrophobic particles (both 40 nm) is substantially lower than the hierarchical equivalent (FIG. 4, B (134°) vs E (92°)). FIG. 4, C, shows that the surface properties of the 4.5 μm C18QUATSi particles are masked by the 20 nm QUATSi particles, exhibiting a hydrophilic surface dominated by the properties of the nano-particles with very low contact angle (18°). FIG. 4, D composed of hydrophilic 20 nm and 4.5 μm particles (QUATSi) delivers a fully wettable surface (no visible droplets), due to complete surface wetting.

### 2.3.2 AFM Imaging

The hierarchical structures of these self-assembled surfaces was studied and confirmed by atomic force microscopy (AFM), across a range of scan dimensions for mixtures A to D. For mixture E, no hierarchical structure was observed. FIG. 5a shows an image over an area of 10×5 μm, where the presence of 4.5 μm-particles over the surface results in the larger topographic differences whilst the higher frequency variations confirm the presence of nano-particles across the structured surface. The presence of 7 nm nano-particles is clearly visible when the scan area is smaller as shown in FIG. 5b.

### 2.3.3 Anti-Viral Efficacy

The hierarchical structured coatings also exhibited greater antiviral efficacy, in comparison to non-hierarchical surfaces (FIG. 6). Structured surface B in-particular (hydrophilic micro-structured base layer with a nano-structured antiviral, hydrophobic surface) exhibited both high water repellence (contact angle=134°, FIG. 4, Entry B) and high anti-viral efficacy (log kill of >2, FIG. 6, B). This is a significant improvement over log kill values of only 0.3-0.5 for similar contact angles, 132-141°, for the equivalent non-hierarchical coating. Hydrophilic, hierarchical coatings based on 20 nm structured antiviral hydrophilic particles structured over either a hydrophobic (FIG. 6, C) or hydrophilic (FIG. 6, D) 4.5 μm structure also showed higher log kill (2.8-2.9) in comparison to non-hierarchical surfaces of equivalent static contact angle (50-100% QUATSi, log kill 2.1-2.5). Structured surface A exhibited relatively low antiviral efficacy, presumably due to the exceptionally high static contact angle>165° (FIG. 6, A).

The characteristic combination of a high static contact angle with high antiviral efficacy observed in Entry B, FIG. 4 is a resulting property of the ‘multi-tiered’ hierarchical surface structure.

### 2.3.4 Abrasion Testing

The multi-tiered hierarchical structured surfaces were subjected to abrasion testing. Surface abrasion was conducted with a microfibre fabric surface at a constant weight (0.05 kg) and abrasion rate (0.06 ms⁻¹). The glass slide was placed coating-side down onto a microfibre cleaning cloth and a 50 g weight placed on top. The slide was pulled over a 30 cm distance over a time of ^{˜}5 seconds. Static contact angles were measured before abrasion, and after 1 and 2 abrasion cycles to determine the robustness of the resulting surface. This process was sufficient to remove the hierarchical structured surfaces based on all of the bimodal suspensions A to D, suggesting a lack of robustness of the surfaces.

### 2.4 Evaluation of Robustness

A major challenge associated with the preparation of structured surfaces arises from the lack of robustness of the surfaces, with mild abrasion or skin contact often sufficient to deteriorate the coatings.

To obtain a robust structured coating a thin film PDMS adhesive binder was used. Following application of the PDMS adhesive binder, a suspension of micro-silica (1 wt %) with Karstedt catalyst, in propan-2-ol was applied to deliver a mechanically robust, single tier-structured coating for study.

The following solutions were prepared:

TABLE 2
Catalyst/binder solutions

| Solution | Components |
|---|---|
| Catalyst Solution A | 0.05 ml of Karstedt catalyst (Platinum(0)-1,3- |
| | divinyl-1,1,3,3-tetramethyldisiloxane |
| | complex solution) dissolved in 10 ml hexane |
| Catalyst Solution B | 0.05 ml of Karstedt catalyst (Platinum(0)-1,3- |
| | divinyl-1,1,3,3-tetramethyldisiloxane |
| | complex solution) dissolved in 10 ml propan-2-ol |
| 1 ml Sylgard ™ 184 base dissolved in 19 ml | Sylgard ™ solution 1 |
| hexane | |

### 2.4.1 Binder Formulation

0.1 ml Sylgard™ 184 curing agent was added to Sylgard™ solution 1 (i.e. 1:10 ratio by volume, according to the manufacturer's instructions), followed by the addition of 1 ml of ‘Catalyst Solution A’. This mixture was sonicated for 10 minutes then sprayed onto glass slides (2 ml per slide) following the spray application process described previously.

### 2.4.2 Micro-Particle Suspension

A pre-prepared 4.5 μm silica (C18Si functional, AHYDR) suspension in propan-2-ol (1 wt %, 20 ml) was sonicated for 10 minutes before spraying on top of the PDMS layer applied in 2.4.1 at predetermined time intervals, using the standard spraying application process. Samples were cured at ambient temperature for 24 hours.

2.4.2.1 Micro-Particle Suspension with Cure Accelerator

To investigate the effect of a cure accelerator on the drying process, 1 ml of ‘Catalyst Solution B’ (i.e. the Karstedt catalyst described above) was added to a pre-prepared 4.5 μm silica (C18Si functional, AHYDR) suspension in propan-2-ol (1 wt %, 20 ml). Again, this was sonicated for 10 minutes before spraying on top of the PDMS layer applied in 2.4.1 at predetermined time intervals, using the standard application process. Samples were cured at ambient temperature for 24 hours.

### 2.4.3 Abrasion Testing of the Resulting Coatings

Surface abrasion was conducted with a microfibre fabric surface at a constant weight (0.05 kg) and abrasion rate (0.06 ms⁻¹). The glass slide was placed coating-side down onto a microfibre cleaning cloth and a 50 g weight placed on top. The slide was pulled over a 30 cm distance over a time of ^{˜}5 seconds. Static contact angle were measured before abrasion, and after 1 and 2 abrasion cycles to determine the robustness of the resulting surface. The results for the ‘normal’ and ‘accelerated cure’ (i.e. with catalyst added to the particle suspension) are shown in FIG. 7.

FIG. 7 shows the control systems of PDMS only and micro-silica (4.5 μm, C18Si) only, respectively, as the first two entries. PDMS alone shows the expected static contact angle of ^{˜}117° for the PDMS surface, which is robust and does not change upon abrasion (1 or 2 cycles). Micro-particle coatings applied directly to the substrate showed a static contact angle of ^{˜}150°. This value dropped to 60° and 56° after 1 and 2 abrasion cycles respectively, which is approximately equal to the static contact angle of untreated glass (^{˜}52°). These results demonstrate the poor abrasion resistance of micro-particle structured surfaces when applied directly to a substrate.

An application window of 10-45 minutes was studied, for the spray coating of the particle suspension over the curing PDMS binder. FIG. 7 (top) shows that when the suspension is applied over the PDMS binder between 39-45 minutes after application of the PDMS to the substrate, the micro-silica structured surface is present on the surface of the coating. This is characterised by a static contact angle of >140° characteristic of the micro-silica structured surface (FIG. 7 (top)). These surfaces show for the first time, no significant loss of hydrophobicity on abrasion testing within one or two cycles (FIG. 7 (top)). Further testing revealed that there was no significant loss in hydrophobicity after 10 abrasion cycles.

FIG. 7 (bottom) shows comparative results when the cure catalyst is added to the particle formulation. It advantageously shows that the inclusion of the additional catalyst with the micro-silica particle formulation successfully expanded the application window (FIG. 7, bottom). Static contact angles within this new expanded application window (FIG. 7 (bottom), highlighted) are consistently higher compared to the equivalent time points without additional cure catalyst. Abrasion data also shows improved resistance to mechanical damage, further highlighting the advantages of this formulation improvement.

To study this effect, droplet imaging was carried out using a droplet shape analyser, and the results are shown in FIG. 8. The droplet images taken over a 45-minute time window for the spray application of 4.5 μm particles treated with C18Si onto PDMS binder clearly show that from 30 minutes onwards the particle starts to present at the surface rather than submerge into PDMS layer. This demonstrates the development of a robust hydrophobic surface once sufficient PDMS cure has occurred, allowing the micro-particles stay on the surface. The surface cure can be accelerated through the inclusion of catalyst in the particle suspension.

### 2.5 Preparation of Robust Hierarchical Structured Surfaces

A mechanically robust, hierarchical structured coating with surface active (antiviral) functionality at the surface was prepared according to the invention. This method is illustrated schematically in FIG. 9 and shows the application of micro-silica particles (4.5 μm, C18Si) suspended in PDMS binder to a glass substrate. A suspension comprising 7 nm silica particles functionalised with C18QUATSi is then applied to the partially cured PDMS-microsilica basecoat. 10 repeated abrasion cycles were then carried out. Further details are below.

### 2.5.1 Preparation of First Formulation

‘Sylgard™ solution 1′ (10 ml) was combined with the Sylgard™ curing agent (0.05 ml) and catalyst solution A (0.5 ml) and sonicated in an ultrasonic bath for 5 minutes. A pre-prepared 4.5 μm silica (C18Si functional, AHYDR) suspension in propan-2-ol (1 wt %, 10 ml) was added to this solution and sonicated for a further 5 minutes. This first formulation mixture was sprayed onto glass microscope slides (×8) and left to dry for 10-60 minutes.

### 2.5.2 Preparation of Second Formulation

A suspension of 7 nm C18QUATSi (ANHYD) functional nano-particles in propanol-2-ol (1 wt %, 16 ml) was combined with ‘Catalyst Solution B’ (1 ml) and sonicated in an ultrasonic bath for 10 minutes. The resulting suspension was then applied to the pre-prepared ‘micro-structured PDMS’ substrate, at the pre-determined time intervals of 10-60 minutes, using the standard application procedure. Samples were then cured at ambient temperature for 24 hours.

### 2.5.3 Abrasion Testing of the Resulting Coatings

Surface abrasion was conducted with a microfibre fabric surface at a constant weight (0.05 kg) and abrasion rate (0.06 ms⁻¹). The glass slide was placed coating-side down onto a microfibre cleaning cloth and a 50 g weight placed on top. The slide is pulled over a 30 cm distance over a time of ^{˜}5 seconds. Static contact angle were measured before abrasion, and after 1 and 2 abrasion cycles to determine the robustness of the resulting surface.

### 2.5.4 Static Water Contact Angle Measurement

The difference in characteristic static contact angle of PDMS (114-120°), 7 nm (C18QUATSi) non-hierarchical surfaces (135-140°) and 7 nm (C18QUATSi) on 4.5 μm hierarchical surface (140-155°) were used to characterize the resultant surface type, supported by AFM imaging.

### 2.5.5 Application Window and Robustness Study

An application window and robustness study was conducted for the hierarchical structured surface according to the invention (PDMS, C18Si, 4.5 μm particles applied as a first formulation and C18QUATSi, 7 nm particles applied as a second formulation). The resulting hierarchical structured surface comprise a micro-particle base layer with C18QUATSi nano-particle hierarchical upper layer. Catalyst accelerated cure of the nano-surface coating was again effective in promoting robustness and reproducibility of structured surfaces. The coatings with no polymeric binder showed the expected poor mechanical robustness, with complete removal of nanoparticle layer after a single abrasion cycle. The optimised robust, superhydrophobic hierarchical coatings of the invention, achieved static contact angles as high as 155°, with excellent abrasion resistance and consistent performance across a wide application window (FIG. 10, highlighted, versus the poor mechanical robustness demonstrated for the coatings in Example 2.3.4). Minimal loss of hydrophobicity was observed after multiple abrasion testing, highlighting this methodology as producing robust, hierarchical structured surfaces by simple spray application.

### 2.5.6 Evaluation of Hierarchical Structure

Topographic images of both the micro-structured PDMS base layer and the hierarchical ‘nano-on micro-structured surfaces’ were acquired using AFM tapping mode imaging techniques. The results of these experiments show clear evidence for the hierarchical structure according to the invention. The samples were imaged over different scan sizes to investigate the single-tier microstructure and the multi-tier hierarchical structure of the surfaces. FIG. 11a shows an image of micro-structured base layer (PDMS with micro-particle, C18Si) binder sample over an area of 90×90 μm, where the presence of 4.5 μm-particles over the surface results in the peaks visible on the image. The distribution of micro-particles is clearly visible, especially when the scan area is smaller, as shown in FIG. 11b. The height of the features can be seen in FIG. 11c over the lines labelled in FIG. 11b. The same methodology was applied to investigate the hierarchical ‘nano-on micro-structured surfaces’ (PDMS with 4.5 μm particle (C18Si) base layer plus 20 nm particle (C18QUATSi) upper layer) as shown in 11d-f. The distribution of 4.5 μm-particles results in the larger topographic differences in these images whilst the higher frequency variations (seen in FIG. 11f) are due to the presence of C18QUATSi nano-particles across the surface of the coating.

The invention advantageously relates to a versatile method for the preparation of self-assembled, multi-tiered structured surfaces that optimise both functional (e.g. anti-viral) and hydrophobic (easy-clean) properties. The methodology exploits the availability of surface-active functional groups and uses the surface micro-/nano-structure to control the way the surface coating interacts with molecules and the surrounding environment. This methodology demonstrates significant advantages over single-tier functional structured surfaces, including the ability to overcome droplet pinning effects. In addition, the method of the invention presents a simple route to robust structured coatings that maintain both the hierarchical nano-on micro-surface features while allowing exploitation of surface-active functional groups. The method of the invention can be performed using readily available materials and a scalable spray application process using non-specialist equipment for a wide variety of applications.

1. A method of preparing a hierarchical structured surface, the method comprising:
applying a first formulation, the first formulation comprising particles with a median particle diameter, D₅₀, in the range of from 500 nm to 1,000 μm, and a polymeric binder; and
subsequently applying a second formulation comprising particles with a median particle diameter, D₅₀, in the range of from 1 nm to 450 nm, onto the first formulation, to prepare a hierarchical structure.

2. A method as claimed in claim 1, wherein the second formulation comprises a cure accelerator.

3. A method as claimed in claim 1 or claim 2, wherein the particles of the first formulation have a median particle diameter D₅₀, in the range of from 1 μm to 100 μm and particles of the second formulation have a median particle diameter D₅₀, in the range of from 1 nm to 100 nm.

4. A method as claimed in any preceding claim, wherein the particles of the first and/or second formulation are functionalised.

5. A method as claimed in claim 4, wherein the particles of the first formulation are functionalised with a functional group comprising a C1-C25 alkyl chain

6. A method as claimed in claim 4 or claim 5, wherein the particles of the second formulation are anti-viral, anti-bacterial or anti-microbial.

7. A method as claimed in any of claims 4 to 6, wherein the particles of the second formulation are functionalised with a functional group comprising a C1-C25 alkyl chain.

8. A method as claimed in claim 7, wherein the C1-C25 alkyl chain contains a quaternary ammonium group.

9. A method as claimed in any preceding claim, wherein the first formulation and/or the second formulation are applied by spray-coating.

10. A method as claimed in any preceding claim, wherein the polymeric binder is selected from polydimethylsiloxane (PDMS), polyurethane, polysilicone, polysiloxane, polyacrylate, polyolefin, polyester, polycarbonate, polyamide, polyamine, epoxy, epoxy-amine, epoxy-phenolic, epoxy-polyester, melamine, melamine formaldehyde, alkyds.

11. A method as claimed in any preceding claim, wherein the first formulation comprises a cure accelerator.

12. A method as claimed in any preceding claim, wherein the hierarchical structured surface has a static water contact angle of >140°.
